(19) United States
(12) Patent Application Publication
(10) Pub. No.: US 2012/0073458 A1
(43) Pub. Date: Mar. 29, 2012

(54) Crimping and inking notary seal

(76) Inventor: Karen J. Wirtz, Franksville, WI (US)

(21) Appl. No.: 13/200,119

(22) Filed: Sep. 19, 2011

Related U.S. Application Data
(60) Provisional application No. 61/403,577, filed on Sep. 17, 2010.

(51) Int. Cl. B44B 5/00

(52) U.S. Cl. 101/31.1

(57) ABSTRACT

The invention provides an integrated inkpad and embosser which serves to apply ink and emboss simultaneously the surface of a document. The device applies ink to only the embossed areas of a document. Thus perfectly rendering the seal easily visible on originals and copies. Positioned on the distal end of the unit is a set of two embossing plates which emboss and ink a document when the jaws of the plates are squeezed together. The novel feature taught by the present invention is the inclusion of an inkpad positioned on the bottom of the upper jaw so that ink is applied to the surface of the document when the jaws are squeezed together. The inkpad is covered with a surface having openings to allow the flow of ink selectively to the tops of the embossed characters.

### CLAIM OF PRIORITY

This patent application claims priority under 35 USC 119 (e) (1) from U.S. Provisional Patent Application Ser. No. 61/403,577 filed Sep. 17, 2010, of common inventorship herewith entitled, “Wirtz Crimping and Inking Notary Seal.”

### FIELD OF THE INVENTION

The present invention pertains to the field of legal endorsement devices, and more specifically to the field of notary and other seal embossing devices.

### BACKGROUND OF THE INVENTION

The prior art has put forth several designs for notary and other seal embossing devices. Among these are:

U.S. Pat. No. 1,679,029 to Calder C. Gibson describes a seal press of the type employed by courts, notaries public and corporations for impressing a seal on documents or other papers. The frame is so constructed that the same is stronger and can stand in an upright position on a table or similar support, which is small enough to be carried in the pocket and which will also permit of curling the sheet which is to be stamped or sealed so that the impression can be placed further from the edge of the sheet.

U.S. Pat. No. 3,260,192 to William H. Ostenberg describes a seal with a detachable operating lever or handle, and which when detached and removed from its normal die-operating position, can be fitted in a storage position on the base or bottom of the seal, thereby materially reducing the overall size of the seal and rendering it more compact for portability or storage.

U.S. Pat. No. 3,491,719 to Stephen J. Rudy describes an embossing device including male and female interfitting die members for embossing a paper-like material interposed between said die members, and a lever means for causing relative movement between said die members, an improvement comprising an inking means for inking an embodiment after it is formed by said die members, said inking means including a roller recessed in one of said frame means or lever means and which is rotatably supported so that a peripheral portion of the roller may be brought into rolling contact with crest portions of said embossment.

None of these prior art references describe the present invention.

### SUMMARY OF THE INVENTION

It is an object of the present invention to provide a notary and other seal embossing device which inks and embosses the surface of a document or paper simultaneously.

### BRIEF DESCRIPTION OF THE DRAWINGS

FIG. 1A is an elevational angled perspective view of the device of the present invention.

FIG. 1B is a cross section of a portion of the device of the present invention showing the inkpad surface cover with holes which inks the raised surfaces of the embossing characters when the jaws of the crimper are squeezed together.

FIG. 2 shows an inked seal from a prior art device which does not emboss the paper.

FIG. 3 shows an embossed seal from a prior art devices which does not have inking capabilities.

FIG. 4 shows an inked and embossed seal from the device of the present invention.

FIG. 5 is a schematic side view of the device of the present invention showing the plate holder, the male plate, the female plate the ink pad and the screw cap above the ink pad.

FIG. 6 is a side view showing the ink pad and the ink pad cartridge.

FIG. 7 is a perspective view of the ink pad cartridge showing the adjustable screw top and the plate holder and support rim and the chamber in the cartridge for holding the ink pad and the bottom surfaces with indentations and holes to bold the embossing plate.

FIG. 8 is a side view similar to FIG. 1B which shows the holes for the flow of ink to the peaks of the embossing characters.

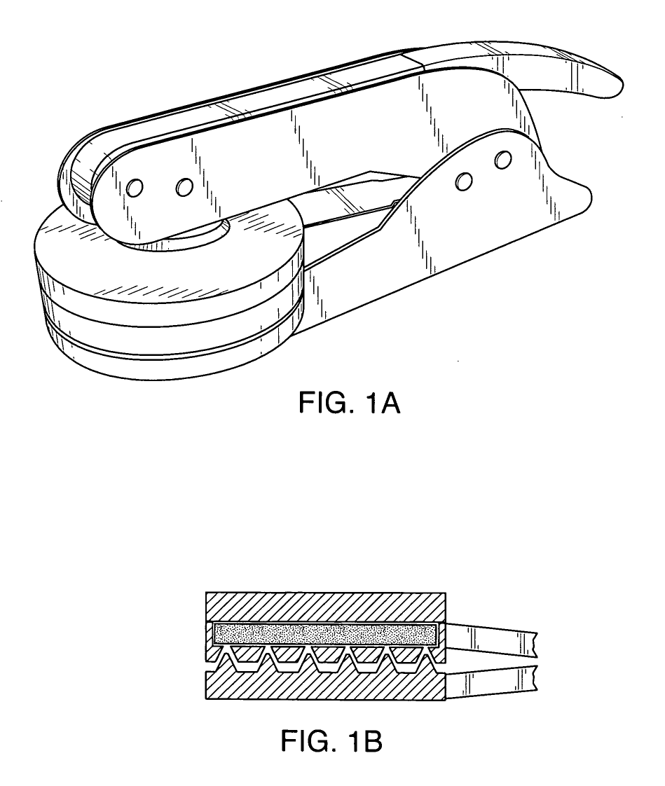

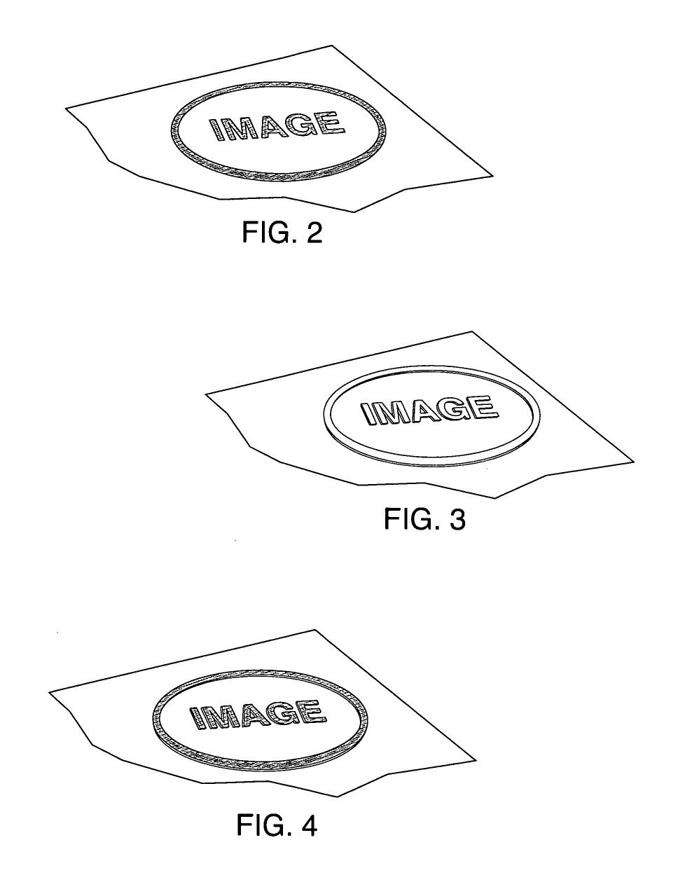

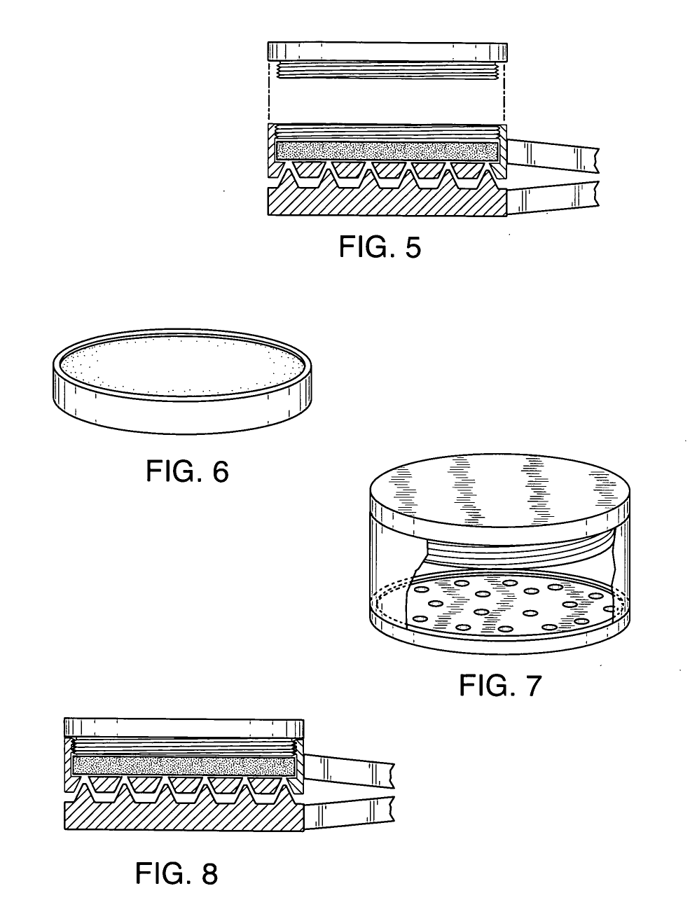

### DETAILED DESCRIPTION OF THE INVENTION

The present invention, hereinafter referred as The Wirtz Crimping & Inking Notary Seal, features an integrated inkpad and embosser which serves to apply ink and emboss simultaneously the surface of a document. The device applies ink to only the embossed areas of a document. Thus perfectly rendering the seal easily visible on originals and copies.

Similar in appearance to traditional portable and desktop embossers, the present invention is manufactured primarily of heavy-duty stainless steel or comparable materials. Additionally, desktop models feature a nonskid base.

Positioned on the distal end of the unit is a set of two embossing plates an ink pad which emboss and ink a document when the jaws of the plates are squeezed together. The lower plate features a raised surface, and the upper plate features a corresponding female design inside of which the male plate snugly abuts. Customized with the user's own notary seal, these two plates are drawn together and clamped over a document via an ergonomically designed handle. The novel feature taught by the present invention is the inclusion of an inkpad positioned on the top of the upper jaw so that ink is applied to the surface of the document when the jaws are squeezed together. The inkpad may be covered with a surface having openings to allow the flow of ink selectively to the tops of the embossed characters.

The design stamped/etched into the female plate is open just at the tips. Openings may include holes or slotted spacing to support letter centers and allow controlled flow of ink to the surface of the paper. This allows ink to be applied only onto the designated embossed areas. Each time the embosser is utilized, ink is applied simultaneously while the document is crimped. The inkpad is a replaceable black or colored inkpad, which is inserted inside the metal top cover above female plate. The inkpad positioned directly above the female top plate can be adjusted for varied paper types and aging inkpad variances wherein the adjustment is accomplished by turning the top screw-on-cover up or down to vary pad pressure. The screw on cover is completely closed at all times during non-use, the entire unit can be locked closed to promote inkpad longevity.

The Wirtz Crimping & Inking Notary Seal enables certified notaries to emboss and stamp a document simultaneously. This eliminates the need to utilize a separate embosser and stamp. The Wirtz Crimping & Inking Notary Seal ensures a crisp embossed seal, which is easily read and photocopied.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A notary and other seal embossing and inking device, comprising an embosser comprising an upper plate and a lower plate which emboss the surface of a document when the plates are squeezed together and an inkpad on the lower surface of the upper plate of the device wherein the inkpad serves to apply ink when the plates are squeezed together.

2. The device of claim 1 wherein the lower plate features a raised surface, and the upper plate features a corresponding female design inside of which the male plate snugly abuts.

3. The device of claim 1 wherein the lower surface of the inkpad is covered with a covering having openings to allow selective dispersal of the ink onto the surface of the document.

4. The device of claim 3 wherein the openings are holes or slots.

5. The device of claim 4 wherein the openings are placed into at the tips of the raised characters of the lower plate.

6. The device of claim 1 wherein the inkpad is a replaceable black or colored inkpad, which is inserted inside the metal top cover above female plate, and the inkpad has a screw on cover.

7. The device of claim 6 wherein the inkpad positioned directly above the female top plate is adjusted for varied paper types and aging inkpad variances wherein the adjustment is accomplished by turning the top screw-on-cover up or down to vary pad pressure.

8. The device of claim 6 wherein the screw on cover of the inkpad can be completely closed during non-use, so the unit can be locked closed to promote inkpad longevity.
